(19) United States
(12) Patent Application Publication
(10) Pub. No.: US 2026/0204013 A1
(43) Pub. Date: Jul. 16, 2026

(54) MANAGEMENT METHOD OF THREE-DIMENSIONAL OBJECT AND OBJECT MANAGEMENT APPARATUS

(71) Applicant: Wistron Corporation, New Taipei City (TW)

(72) Inventors: Ping Hsin Liu, New Taipei City (TW); Shih Hao Liu, New Taipei City (TW); Hsin Hui Liao, New Taipei City (TW)

(73) Assignee: Wistron Corporation, New Taipei City (TW)

(21) Appl. No.: 19/071,611

(22) Filed: Mar. 5, 2025

(30) Foreign Application Priority Data
Jan. 14, 2025 (TW) 114101466

(51) Int. Cl. G06T 17/00

(52) U.S. Cl. CPC G06T 17/00

(57) ABSTRACT

A management method of a three-dimensional object and an object management apparatus are provided. In the management method, object data of a three-dimensional object is obtained, the object data is converted into geometric relational data, and a similarity value between the geometric relational data of the three-dimensional object and reference relational data is determined. The object data defines position information of the three-dimensional object in a three-dimensional space. The geometric relational data is converted based on the position information of a plurality of first reference points on the three-dimensional object, and the first reference points define a shape of the three-dimensional object. The reference relational data is converted based on position information of a plurality of second reference points on a reference object. The second reference points define a shape of the reference object, and the similarity value represents a degree of similarity in shape between the three-dimensional object and the reference object. Thereby, a mechanism for comparison of a degree of similarity is provided for a three-dimensional object.

### CROSS-REFERENCE TO RELATED APPLICATION

This application claims the priority benefit of Taiwan application serial no. 114101466, filed on Jan. 14, 2025. The entirety of the above-mentioned patent application is hereby incorporated by reference herein and made a part of this specification.

### BACKGROUND

### Technical Field

The disclosure relates to a three-dimensional object technology, and particularly relates to a management method of a three-dimensional object and an object management apparatus.

### Related Art

With the rapid development of technology, the application of three-dimensional (3D) models has become increasingly widespread, covering diverse fields such as digital twins and 3D software collaboration. However, the intellectual property protection mechanism for 3D models has not been able to keep pace with the speed of application, resulting in frequent leakages of models, which seriously damage the intellectual property rights of companies owning the 3D models.

For example, there have been incidents in the past where 3D model files of well-known animations were not encrypted, and were leaked and made available for 3D printing on the internet. There were even leaked screenshots of unreleased mechanical parts.

Currently, the technology commonly used in the market for searching or verifying image objects is image-based search. However, there is no such a mechanism for 3D file objects.

### SUMMARY

The disclosure provides a management method of a three-dimensional object and an object management apparatus, for verifying whether a three-dimensional object has been plagiarized.

A management method of a three-dimensional object according to an embodiment of the disclosure is implemented through a processor. The management method includes: obtaining object data of a three-dimensional object; converting the object data into geometric relational data; and determining a similarity value between the geometric relational data of the three-dimensional object and reference relational data. The object data defines position information of the three-dimensional object in a three-dimensional space. The geometric relational data is converted based on the position information of multiple first reference points on the three-dimensional object, and the first reference points define a shape of the three-dimensional object. The reference relational data is converted based on position information of multiple second reference points on a reference object, and the second reference points define a shape of the reference object. The similarity value represents a degree of similarity in shape between the three-dimensional object and the reference object.

An object management apparatus according to an embodiment of the disclosure includes an input device, a storage device, and a processor. The input device obtains object data of a three-dimensional object. The object data defines position information of the three-dimensional object in a three-dimensional space. The storage device stores a program code. The processor is coupled to the input device and the storage device. The processor loads the program code and is configured to: convert the object data into geometric relational data; and determine a similarity value between the geometric relational data of the three-dimensional object and reference relational data. The geometric relational data is converted based on position information of multiple first reference points on the three-dimensional object, and the first reference points define a shape of the three-dimensional object. The reference relational data is converted based on position information of multiple second reference points on a reference object, and the second reference points define a shape of the reference object. The similarity value represents a degree of similarity in shape between the three-dimensional object and the reference object.

Based on the above, the management method of a three-dimensional object and the object management apparatus according to the embodiments of the disclosure convert the position information of multiple reference points into geometric relational data, and compare the geometric relational data with reference relational data to determine the degree of similarity between the three-dimensional object and the reference object. In this way, the disclosure provides a mechanism for verifying the degree of similarity between three-dimensional objects, thereby enhancing the strength of intellectual property protection.

To make the aforementioned features and advantages of the disclosure more comprehensible, exemplary embodiments are described in detail hereinafter in conjunction with the accompanying figures.

### BRIEF DESCRIPTION OF THE DRAWINGS

FIG. 1 is a component block diagram of an object management apparatus according to an embodiment of the disclosure.

FIG. 2 is a flowchart of a management method of a three-dimensional object according to an embodiment of the disclosure.

FIG. 3 is a schematic diagram of a three-dimensional object according to an embodiment of the disclosure.

FIG. 4 is a schematic diagram of first vectors according to an embodiment of the disclosure.

FIG. 5 is a schematic diagram of second vectors according to an embodiment of the disclosure.

FIG. 6A is a schematic diagram of vectors of geometric relational data of a three-dimensional object according to an embodiment of the disclosure.

FIG. 6B is a schematic diagram of vectors of reference relational data of a reference object according to an embodiment of the disclosure.

FIG. 6C is a schematic diagram of angle-related similarity values according to an embodiment of the disclosure.

FIG. 7A is a schematic diagram of a three-dimensional object to be evaluated according to an embodiment of the disclosure.

FIG. 7B is a schematic diagram of reference objects and corresponding similarity values according to an embodiment of the disclosure.

FIG. 8A is a schematic diagram of a three-dimensional object to be evaluated according to an embodiment of the disclosure.

FIG. 8B is a schematic diagram of reference objects and corresponding similarity values according to an embodiment of the disclosure.

### DESCRIPTION OF THE EMBODIMENTS

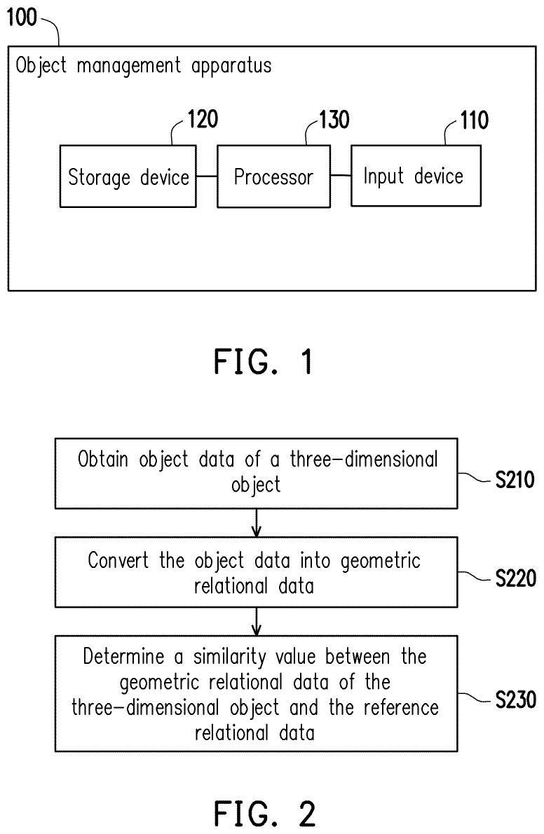

FIG. 1 is a component block diagram of an object management apparatus 100 according to an embodiment of the disclosure. Referring to FIG. 1, the object management apparatus 100 includes (but is not limited to) an input device 110, a storage device 120, and a processor 130. The object management apparatus 100 may be a smart phone, a tablet computer, a laptop computer, a desktop computer, a server, a voice assistant device, a smart home appliance, a wearable device, or other electronic devices.

The input device 110 may be a communication transceiver (for example, a transceiver circuit supporting mobile communication, Wi-Fi, or Ethernet) or a transmission interface (for example, USB interface, Thunderbolt interface, or optical fiber network interface).

In an embodiment, the input device 110 is configured to receive object data of a three-dimensional object generated or stored by other electronic devices. The three-dimensional object may be a structural object, an equipment object, a human object, a furniture object, an electrical appliance object, or other types of objects. That is, the object type of the three-dimensional object may be structure, equipment, human, furniture, electrical appliance, or other types. The structural object, for example, corresponds to a wall, a door, a pillar, a beam, or a window. According to different application requirements, the equipment corresponding to the equipment object may be suitable for a factory, an office, a house, a school, or other environments. In terms of a factory, the equipment object may correspond to manufacturing equipment, but is not limited thereto. The human object corresponds to various types of people, the furniture object corresponds to various types of furniture, and the electrical appliance object corresponds to various types of electrical appliances. It should be noted that the object type of the three-dimensional object may still be changed according to actual requirements.

The object data defines position information of the three-dimensional object in a three-dimensional space, such as it includes the positions of the vertices of a 3D object, vertex normals, and texture coordinates. In an embodiment, the file format of the object data may be OBJ, STL (Stereolithography), FBX (Filmbox), 3DS (3D Studio), or STEP (Standard for the Exchange of Product model data), but is not limited thereto.

The storage device 120 may be any type of fixed or removable random access memory (RAM), read only memory (ROM), flash memory, conventional hard disk drive (HDD), solid-state drive (SSD), or similar components. In an embodiment, the storage device 120 is configured to store program codes, software modules, configuration settings, data (for example, object data, geometric relational data, or reference relational data), or files, which will be described in detail in subsequent embodiments.

The processor 130 is coupled to the input device 110 and the storage device 120. The processor 130 may be a central processing unit (CPU), a graphic processing unit (GPU), or other programmable general-purpose or special-purpose microprocessor, digital signal processor (DSP), programmable controller, field programmable gate array (FPGA), application-specific integrated circuit (ASIC), neural network accelerator, other similar components, or a combination of the above components. In an embodiment, the processor 130 is configured to execute all or some of the operations of the object management apparatus 100, and may load and execute various codes, software modules, files, and data stored in the storage device 120.

In the following, the method described in the embodiment of the disclosure will be described in conjunction with various devices, components, and modules in the object management apparatus 100. Each process of this method may be adjusted according to the situation of implementation and is not limited to the illustration here.

FIG. 2 is a flowchart of a management method of a three-dimensional object according to an embodiment of the disclosure. Referring to FIG. 2, the processor 130 obtains object data of a three-dimensional object through the input device 110 (step S210). Specifically, as described above, the object data defines position information of the three-dimensional object in a three-dimensional space. Taking a three-axis coordinate system as an example, the position information may be the coordinates of the vertices, the coordinates of the origin point, the coordinates of the starting and ending points of the vertex normals, the coordinates of the starting and ending points of line segments, or the coordinates of the edges of faces. Nevertheless, the content of the position information may be adjusted according to actual requirements.

In an embodiment, the processor 130 may run a server platform through the input device 110. For example, a web server provides an interface for a user to upload object data. In another embodiment, the processor 130 may receive object data directly transmitted from a USB flash drive, an external hard drive, or a mobile device through the input device 110. However, the source of the object data is not limited to the above scenarios.

The processor 130 converts the object data into geometric relational data (step S220). Specifically, the geometric relational data is converted based on position information of multiple first reference points on the three-dimensional object, and the first reference points define the shape of the three-dimensional object.

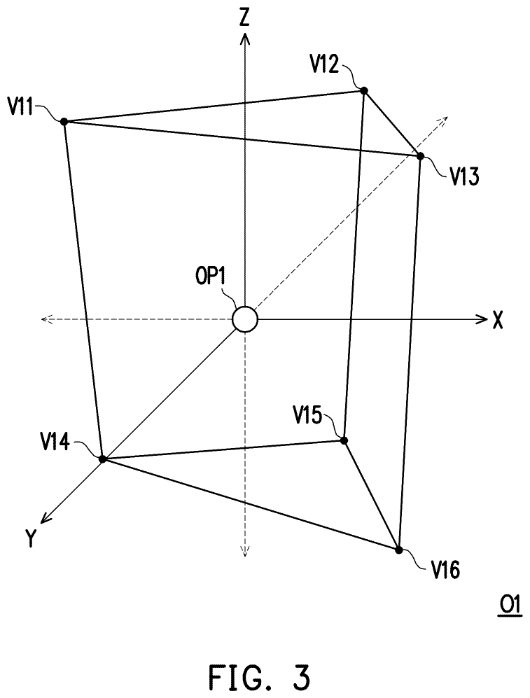

In an embodiment, the first reference points are the vertices and the origin point. For example, FIG. 3 is a schematic diagram of a three-dimensional object O1 according to an embodiment of the disclosure. Referring to FIG. 3, the three-dimensional object O1 is a triangular prism. The three-dimensional object O1 includes vertices V11, V12, V13, V14, V15, and V16. The connection lines between the vertices V11, V12, V13, V14, V15, and V16 form the outline of the three-dimensional object O1. The position information of the vertices V11 to V16 are coordinates on the X, Y, and Z axes. The processor 130 may define the coordinates of the origin point OP1 (as position information) by taking the average of the coordinates of the vertices V11 to V16. Alternatively, the origin point OP1 may also be the geometric center, center of gravity, or other reference centers of the three-dimensional object O1.

In an embodiment, the first reference points are points on multiple faces and the origin point. In a three-dimensional object, each face is formed by multiple points thereon. The processor 130 may determine multiple first vectors from the origin point to the faces respectively. The processor 130 may define the vector with the minimum/shortest distance among multiple vectors from the origin point to multiple points on a certain face as the first vector from the origin point to this face.

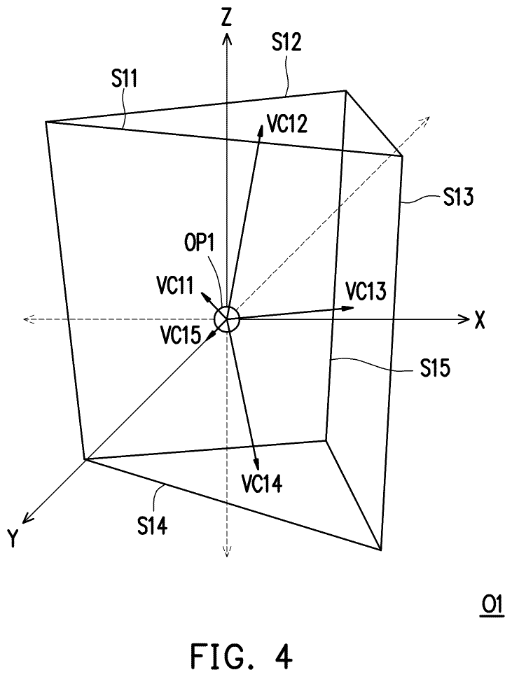

For example, FIG. 4 is a schematic diagram of first vectors VC11, VC12, VC13, VC14, and VC15 according to an embodiment of the disclosure. Referring to FIG. 4, the three-dimensional object O1 includes faces S11, S12, S13, S14, and S15. Additionally, the drawing also presents the first vectors VC11 to VC15 corresponding to the shortest distances from the origin point OP to the faces S11 to S15 respectively.

In an embodiment, the processor 130 may convert the first vectors into geometric relational data. In an embodiment, the geometric relational data includes a hash value. The processor 130 may convert multiple first vectors into the hash value. The hash algorithm may compress a message of arbitrary length into a fixed-length message digest. This fixed-length message digest is called a hash value or a message digest. The processor 130 may convert the values of elements in the first vectors into a (first) hash value through hash algorithms such as MD5, SHA-512, or other hash algorithms.

In an embodiment, the geometric relational data includes a diagonal matrix. The processor 130 may decompose multiple first vectors into a diagonal matrix through singular value decomposition. Singular value decomposition (SVD Decomposition) is a matrix decomposition method that decomposes an m×n real matrix A into the following form:

$$A = U \sum {V}^{T} \qquad ( 1 )$$

where:
U is an m×m orthogonal matrix, whose column vectors are called the left singular vectors of A;
Σ is an m×n diagonal matrix, whose elements on the diagonal are called the singular values of A; and
V^{T} is the transpose of an n×n orthogonal matrix, whose row vectors are called the right singular vectors of A. The processor 130 may combine multiple first vectors corresponding to multiple faces into an m×n matrix, such as a 3×n matrix A (where n is the number of the first vectors), or an m×3 matrix A (where m is the number of the first vectors). By performing singular value decomposition on matrix A, the processor 130 may generate a (first) diagonal matrix Σ.

In an embodiment, the processor 130 may also obtain the singular values of the elements on the diagonal of the diagonal matrix Σ, and generate a singular value vector accordingly. For example, the first vector (i, 0, 0) in the diagonal matrix Σ has a value only in the first element (corresponding to the X-axis); the second vector (0, j, 0) in the diagonal matrix Σ has a value only in the second element (corresponding to the Y-axis); and the third vector (0, 0, k) has a value only in the third element (corresponding to the Z-axis). Therefore, by taking the elements with values from the vectors respectively, a (first) singular value vector (i, j, k) may be generated.

In an embodiment, the geometric relational data includes three flat numeric values on three axes. The processor 130 may flatten multiple first vectors into three flat numeric values. The flattening may flatten a certain vector in the space onto a plane. Taking FIG. 4 as an example, the first vectors VC11 to VC15 are flattened onto the X-Y plane respectively, and the third element corresponding to the Z-axis after flattening is zero. That is, the third elements in the vectors after flattening the first vectors VC11 to VC15 are all zero. It should be noted that the values of other elements (for example, the first element and the second element) in the flattened vectors may be positive or negative. The processor 130 may take the absolute values of the values of the elements. Furthermore, the processor 130 may sum up the vectors after flattening the first vectors VC11 to VC15 to serve as a representative vector for the flattening of the first vectors VC11 to VC15 corresponding to the X-Y plane (that is, a vector composed of the sum of the first elements, the sum of the second elements, and the sum of the third elements (whose value is zero)). The processor 130 may further reduce the dimension of the representative vector for the flattening corresponding to the X-Y plane to remove the third element with a value of zero (that is, only retaining the sum of the first elements and the sum of the second elements) (as a (first) flat numeric value on one of the three axes).

Similarly, the processor 130 may flatten the first vectors VC11 to VC15 onto the Y-Z plane respectively, determine a representative vector for the flattening of the first vectors VC11 to VC15 corresponding to the Y-Z plane (that is, a vector composed of the sum of the first elements (whose value is zero), the sum of the second elements, and the sum of the third elements), and reduce the dimension to a vector with only the sum of the second elements and the sum of the third elements (as a (first) flat numeric value on another of the three axes). Furthermore, the processor 130 may flatten the first vectors VC11 to VC15 onto the X-Z plane respectively, determine a representative vector for the flattening of the first vectors VC11 to VC15 corresponding to the X-Z plane (that is, a vector composed of the sum of the first elements, the sum of the second elements (whose value is zero), and the sum of the third elements), and reduce the dimension to a vector with only the sum of the first elements and the sum of the third elements (as a (first) flat numeric value on another of the three axes).

In an embodiment, the processor 130 may determine multiple second vectors from the origin point to multiple vertices. The processor 130 may define the vector from the origin point to a certain vertex as the second vector from the origin point to this vertex.

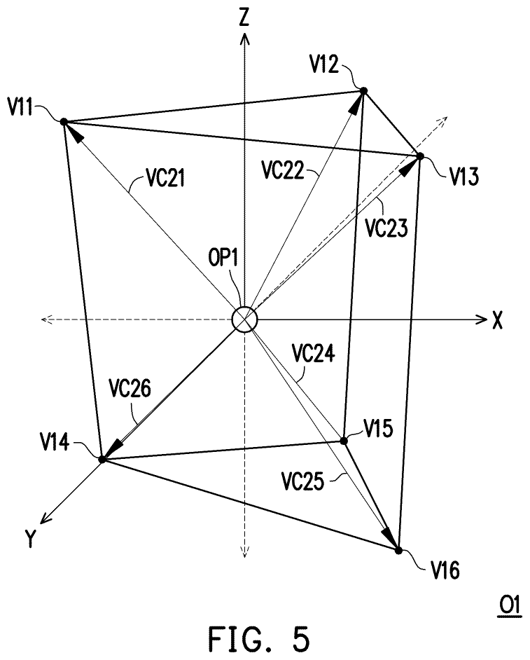

For example, FIG. 5 is a schematic diagram of second vectors VC21, VC22, VC23, VC24, VC25, and VC26 according to an embodiment of the disclosure. Referring to FIG. 5, the three-dimensional object O1 includes vertices V11, V12, V13, V14, V15 and V16. The vectors from the origin point OP of the three-dimensional object O1 to the vertices V11 to V16 are the second vectors VC21, VC22, VC23, VC24, VC25, and VC26 respectively.

In an embodiment, the processor 130 may convert multiple second vectors into geometric relational data. In an embodiment, the geometric relational data includes a hash value. The processor 130 may convert multiple second vectors into the hash value. The processor 130 may convert the values of elements in the second vectors into a (second) hash value through hash algorithms such as MD5, SHA-512, or other hash algorithms.

In an embodiment, the geometric relational data includes a diagonal matrix. The processor 130 may decompose multiple second vectors into a diagonal matrix through singular value decomposition. As described above, by performing singular value decomposition on matrix A (in this case, composed of multiple second vectors), the processor 130 may generate a (second) diagonal matrix Σ.

In an embodiment, the processor 130 may also obtain the singular values of the elements on the diagonal of the (second) diagonal matrix 2, and generate a (second) singular value vector accordingly.

In an embodiment, the geometric relational data includes three flat numeric values on three axes. The processor 130 may flatten multiple second vectors into three flat numeric values. As described above, the vectors are flattened onto the X-Y plane, Y-Z plane, and X-Z plane respectively to generate three (second) flat numeric values on the three axes.

Regarding the hash algorithm, singular value decomposition, and flattening, please refer to the above description of calculation or conversion for the first vectors, which will not be repeated here.

Finally, the geometric relational data of the three-dimensional object O1 in FIG. 4 and FIG. 5 may be summarized as follows:

TABLE 1
Geometric relational data corresponding to the first vector

| | | | | |
|---|---|---|---|---|
| First | First | Corresponding | Corresponding | Corresponding |
| hash | singular | to the first | to the first | to the first |
| value | value | flat numeric | flat numeric | flat numeric |
| | vector | value on the | value on the | value on the |
| | | X-Y plane | Y-Z plane | X-Z plane |

Geometric relational data corresponding to the second vector

| | | | | |
|---|---|---|---|---|
| Second | Second | Corresponding | Corresponding | Corresponding |
| hash | singular | to the second | to the second | to the second |
| value | value | flat numeric | flat numeric | flat numeric |
| | vector | value on the | value on the | value on the |
| | | X-Y plane | Y-Z plane | X-Z plane |

Referring to FIG. 2, the processor 130 determines a similarity value between the geometric relational data of the three-dimensional object and reference relational data (step S230). Specifically, the reference relational data is converted based on position information of multiple second reference points on a reference object, and the multiple second reference points define the shape of the reference object. The reference object is a three-dimensional object previously stored in the storage device 120 or other databases. Therefore, the form and type thereof may be understood by referring to the above description of the three-dimensional object.

The processor 130 or other devices may convert the object data of one or more reference objects into the reference relational data in advance. Referring to the conversion of object data into geometric relational data as described above, the second reference points may be points on multiple faces of the reference object and the origin point, and/or the second reference points may be multiple vertices of the reference object and the origin point. Similarly, the processor 130 or other devices may determine multiple third vectors (corresponding to the aforementioned first vectors) from the origin point to multiple faces of the reference object respectively, and convert the third vectors into reference relational data, such as the hash value, diagonal matrix, and/or three flat numeric values on three axes corresponding to the third vectors. Furthermore, the processor 130 or other devices may determine multiple fourth vectors (corresponding to the aforementioned second vectors) from the origin point to multiple vertices of the reference object respectively, and convert the fourth vectors into reference relational data, such as the hash value, diagonal matrix, and/or three flat numeric values on three axes corresponding to the fourth vectors.

On the other hand, the similarity value represents the degree of similarity in shape between the three-dimensional object and the reference object. In an embodiment, the higher the similarity value, the higher the degree of similarity; the lower the similarity value, the lower the degree of similarity.

In an embodiment, the geometric relational data includes first type data. The first type data may be the first hash value and/or the second hash value. The processor 130 may set the similarity value of the first type data that is identical to the reference relational data to an upper limit value. This upper limit value is the upper limit of the similarity value for single type data. For example, the upper limit value for single type data is 1. The processor 130 may determine whether the (first) hash value corresponding to the first vector is equal to the hash value corresponding to the third vector. In the case where the two hash values are equal, the similarity value corresponding to the first hash value is 1. Conversely, in the case where the two hash values are not equal, the similarity value corresponding to the first hash value is 0 (for example, the lower limit for single type data). Similarly, the processor 130 may determine whether the (second) hash value corresponding to the second vector is equal to the hash value corresponding to the fourth vector. In the case where the two hash values are equal, the similarity value corresponding to the second hash value is 1. Conversely, in the case where the two hash values are not equal, the similarity value corresponding to the second hash value is 0.

In an embodiment, the processor 130 may set the similarity value according to an angle between the vector corresponding to the second type data and the vector corresponding to the reference relational data. The second type data may be the first singular value vector, the second singular value vector, the first flat numeric value, and/or the second flat numeric value. The similarity value may be the cosine similarity. Cosine similarity determines the degree of similarity between two vectors by measuring the cosine value of the angle between the two vectors. The cosine value of a 0-degree angle is 1, representing complete identity, while the cosine value of any other angle is not greater than 1. The minimum cosine value is −1, and the cosine value of any other angle is not less than −1. Furthermore, the cosine value of the angle between two vectors may be used to determine whether the two vectors generally point in the same direction.

In an embodiment, the processor 130 may only take values from 0 to 1 in the cosine value. For example, in the case where two vectors coincide, the cosine value of the angle between the two vectors is 1; in the case where the angle between two vectors is 180 degrees (for example, one vector points left and the other vector points right), the cosine value of the angle between the two vectors is −1; and in the case where the angle between two vectors is 90 degrees, the cosine value of the angle between the two vectors is 0. Therefore, “cosine value=1” represents complete identity, while “cosine value=−1” represents complete dissimilarity. The determination of the degree of similarity may only focus on identity or near similarity, so a negative value may be directly converted into 0. More specifically, in an application scenario, only the case where the angle between two vectors is acute is taken into consideration, but not the cases where the angle is right or obtuse. In cases where the angle is right or obtuse, the degree of similarity corresponding to both vectors may be considered as dissimilar.

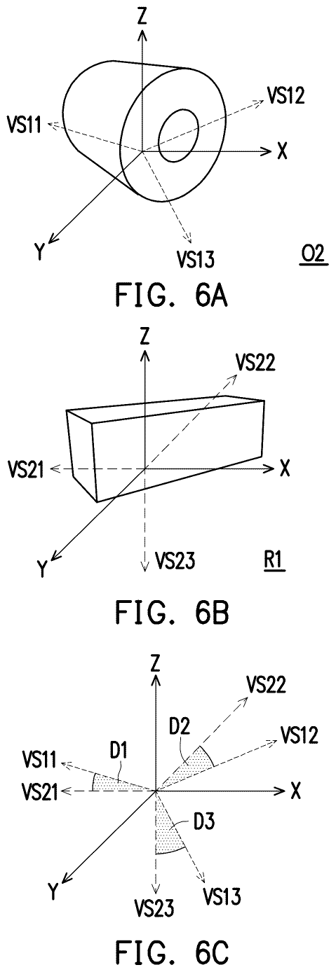

For example, FIG. 6A is a schematic diagram of vectors VS11, VS12, and VS13 of geometric relational data of a three-dimensional object O2 according to an embodiment of the disclosure. Referring to FIG. 6A, the vectors VS11, VS12, and VS13 are, for example, flat numeric values corresponding to the Y-Z plane, X-Z plane, and X-Y plane respectively after flattening of the first vectors.

FIG. 6B is a schematic diagram of vectors VS21, VS22, and VS23 of reference relational data of a reference object R1 according to an embodiment of the disclosure. Referring to FIG. 6B, the vectors VS21, VS22, and VS23 are, for example, flat numeric values corresponding to the Y-Z plane, X-Z plane, and X-Y plane respectively after flattening of the third vectors.

FIG. 6C is a schematic diagram of angle-related similarity values according to an embodiment of the disclosure. Referring to FIG. 6C, the cosine value of the angle D1 between the vector VS11 and the vector VS21 may serve as the similarity value corresponding to the flattening on the Y-Z plane. The cosine value of the angle D2 between the vector VS12 and the vector VS22 may serve as the similarity value corresponding to the flattening on the X-Z plane. The cosine value of the angle D3 between the vector VS13 and the vector VS23 may serve as the similarity value corresponding to the flattening on the X-Y plane.

In an embodiment, the geometric relational data includes multiple types of relational data, such as the hash value, diagonal matrix, and/or three flat numeric values on three axes corresponding to the first vector and/or the second vector. The processor 130 may sum up the similarity values of the geometric relational data with the corresponding reference relational data respectively, and use the sum of the similarity values as a representative value for the similarity value between the three-dimensional object and the reference object. For example, the highest sum of ten similarity values is 10, accurate to twelve decimal places. In an application scenario, to reduce floating-point errors, the value of each similarity value may be multiplied by a fixed value (for example, 1 trillion, 10 trillion, or 100 trillion). In another embodiment, the processor 130 may determine to use the average or other mathematical conversions of the similarity values between multiple pieces of geometric relational data and the corresponding reference relational data as the representative value for the similarity values between the three-dimensional object and the reference object.

In an embodiment, the storage device 120 or databases stores multiple reference objects, and the processor 130 may sort the similarity values (or representative values thereof) corresponding to the multiple reference objects. The higher the ranking (for example, the higher the similarity value), the more the three-dimensional object resembles the reference object. Conversely, the lower the ranking (for example, the lower the similarity value), the more different the three-dimensional object is from the reference object.

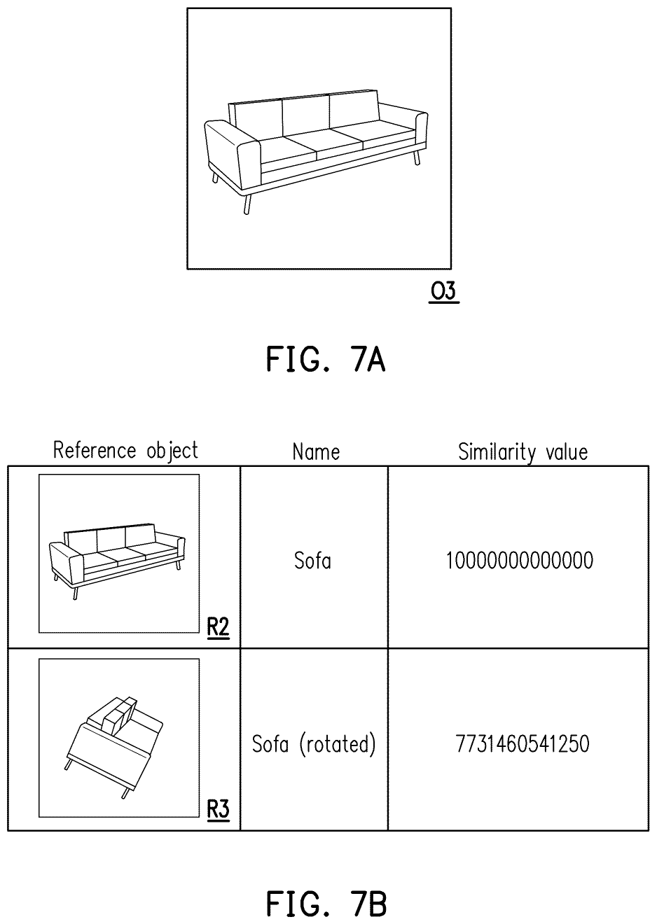

For example, FIG. 7A is a schematic diagram of a three-dimensional object O3 to be evaluated according to an embodiment of the disclosure, and FIG. 7B is a schematic diagram of reference objects R2 and R3 and corresponding similarity values according to an embodiment of the disclosure. Referring to FIG. 7A and FIG. 7B, regarding the type, the three-dimensional object O3 is a sofa object. The reference object R2 is also a sofa object. The similarity value between the three-dimensional object O3 and the reference object R2 is 10000000000000. This similarity value is the upper limit. Therefore, the three-dimensional object O3 is determined to be completely identical to the reference object R2. Although the reference object R3 is also a sofa object, the posture of the reference object R3 is different from the three-dimensional object O3. For example, the reference object R3 is an object rotated in the three-dimensional space, compared to the three-dimensional object O3 shown in FIG. 7A. Therefore, the similarity value between the three-dimensional object O3 and the reference object R3 is smaller than the similarity value between the three-dimensional object O3 and the reference object R2.

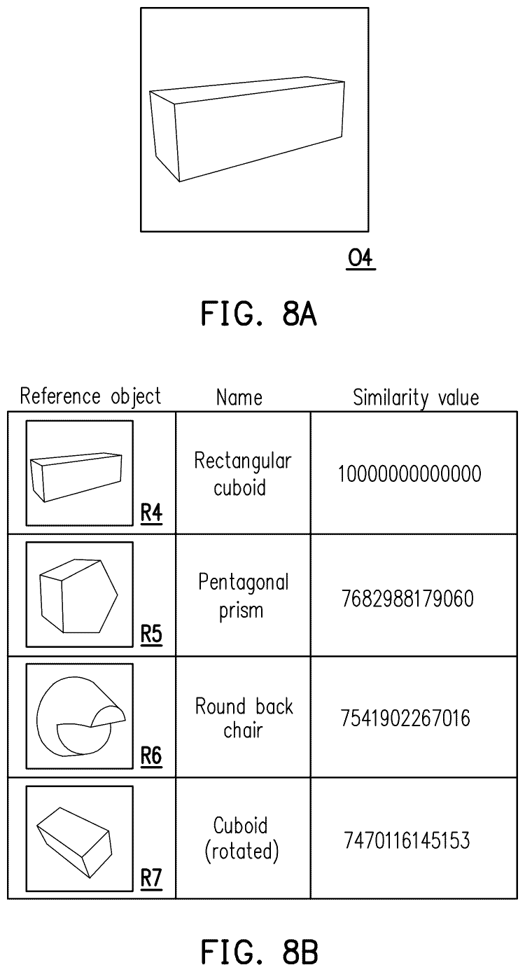

FIG. 8A is a schematic diagram of a three-dimensional object O4 to be evaluated according to an embodiment of the disclosure, and FIG. 8B is a schematic diagram of reference objects R4, R5, R6, and R7 and corresponding similarity values according to an embodiment of the disclosure. Referring to FIG. 8A and FIG. 8B, regarding the type, the three-dimensional object O4 is a cuboid object. The reference object R4 is also a cuboid object with the same posture. The similarity value between the three-dimensional object O4 and the reference object R4 is 10000000000000. Therefore, the three-dimensional object O4 is determined to be completely identical to the reference object R4. Moreover, the similarity values between the three-dimensional object O4 and the reference objects R5, R6, and R7 respectively are all smaller than the similarity value between the three-dimensional object O4 and the reference object R4.

In some application scenarios, three-dimensional objects with complex structures have more vectors from the origin point to faces and/or from the origin point to vertices (which can also be understood as more precise search conditions). There is a chance to generate higher similarity values even if the three-dimensional objects are rotated. An example of such complex-structured three-dimensional objects is the sofa object shown in FIG. 7A. Compared to three-dimensional objects with simple structures (such as the cuboid object shown in FIG. 8A), a rotated object corresponding to a three-dimensional object with a complex structure ranks higher in the sorting of similarity values. For example, the rotated sofa object shown in FIG. 7B ranks second, but the rotated cuboid object shown in FIG. 8B ranks fourth.

To sum up, in the management method of a three-dimensional object and the object management apparatus according to the embodiments of the disclosure, the geometric relational data (for example, hash value corresponding to vectors each formed by two reference points, diagonal matrix obtained from singular value decomposition of vectors, and/or flat numeric values obtained from flattening of vectors) converted from the position information of multiple reference points on the three-dimensional object may be used to compare with the reference relational data of the reference object, and generate similarity values that quantify the degree of similarity between the three-dimensional object and the reference object. Thereby, the embodiments of the disclosure provide a comparison mechanism for the degree of similarity of a three-dimensional object, which can be used to verify whether a three-dimensional object has been leaked or plagiarized.

Although the disclosure has been described with reference to the foregoing embodiments, the embodiments are not intended to limit the disclosure. Any person having ordinary skill in the art may make changes and modifications without departing from the spirit and scope of the disclosure. Therefore, the scope of the disclosure will be defined by the appended claims.

What is claimed is:

1. A management method of a three-dimensional object, implemented through a processor, the management method comprising:
obtaining object data of the three-dimensional object, wherein the object data defines position information of the three-dimensional object in a three-dimensional space;
converting the object data into geometric relational data, wherein the geometric relational data is converted based on the position information of a plurality of first reference points on the three-dimensional object, and the first reference points define a shape of the three-dimensional object; and
determining a similarity value between the geometric relational data of the three-dimensional object and reference relational data, wherein the reference relational data is converted based on position information of a plurality of second reference points on a reference object, the second reference points define a shape of the reference object, and the similarity value represents a degree of similarity in shape between the three-dimensional object and the reference object.

2. The management method of the three-dimensional object according to claim 1, wherein the first reference points comprise points on a plurality of faces and an origin point, and converting the object data into the geometric relational data comprises:
determining a plurality of first vectors from the origin point to the faces respectively; and
converting the first vectors into the geometric relational data.

3. The management method of the three-dimensional object according to claim 2, wherein the geometric relational data comprises a hash value, and converting the first vectors into the geometric relational data comprises:
converting the first vectors into the hash value.

4. The management method of the three-dimensional object according to claim 2, wherein the geometric relational data comprises a diagonal matrix, and converting the first vectors into the geometric relational data comprises:
decomposing the first vectors into the diagonal matrix through singular value decomposition.

5. The management method of the three-dimensional object according to claim 2, wherein the geometric relational data comprises three flat numeric values on three axes, and converting the first vectors into the geometric relational data comprises:
flattening the first vectors into the three flat numeric values.

6. The management method of the three-dimensional object according to claim 1, wherein the first reference points comprise a plurality of vertices and an origin point, and converting the object data into the geometric relational data comprises:
determining a plurality of second vectors from the origin point to the vertices respectively; and
converting the second vectors into the geometric relational data.

7. The management method of the three-dimensional object according to claim 6, wherein the geometric relational data comprises a hash value, and converting the second vectors into the geometric relational data comprises:
converting the second vectors into the hash value.

8. The management method of the three-dimensional object according to claim 6, wherein the geometric relational data comprises a diagonal matrix, and converting the second vectors into the geometric relational data comprises:
decomposing the second vectors into the diagonal matrix through singular value decomposition.

9. The management method of the three-dimensional object according to claim 6, wherein the geometric relational data comprises three flat numeric values on three axes, and converting the second vectors into the geometric relational data comprises:
flattening the second vectors into the three flat numeric values.

10. The management method of the three-dimensional object according to claim 1, wherein the geometric relational data comprises first type data or second type data, and determining the similarity value between the geometric relational data of the three-dimensional object and the reference relational data comprises:
setting the similarity value of the first type data that is identical to the reference relational data to an upper limit value, wherein the upper limit value is an upper limit of the similarity value for single type data; or
setting the similarity value according to an angle between a vector corresponding to the second type data and a vector corresponding to the reference relational data.

11. An object management apparatus, comprising:
an input device obtaining object data of a three-dimensional object, wherein the object data defines position information of the three-dimensional object in a three-dimensional space;
a storage device storing a program code; and
a processor coupled to the input device and the storage device, loading the program code, and configured to:
convert the object data into geometric relational data, wherein the geometric relational data is converted based on the position information of a plurality of first reference points on the three-dimensional object, and the first reference points define a shape of the three-dimensional object; and
determine a similarity value between the geometric relational data of the three-dimensional object and reference relational data, wherein the reference relational data is converted based on position information of a plurality of second reference points on a reference object, the second reference points define a shape of the reference object, and the similarity value represents a degree of similarity in shape between the three-dimensional object and the reference object.

12. The object management apparatus according to claim 11, wherein the first reference points comprise points on a plurality of faces and an origin point, and the processor is further configured to:
determine a plurality of first vectors from the origin point to the faces respectively; and
convert the first vectors into the geometric relational data.

13. The object management apparatus according to claim 12, wherein the geometric relational data comprises a hash value, and the processor is further configured to:
convert the first vectors into the hash value.

14. The object management apparatus according to claim 12, wherein the geometric relational data comprises a diagonal matrix, and the processor is further configured to:
decompose the first vectors into the diagonal matrix through singular value decomposition.

15. The object management apparatus according to claim 12, wherein the geometric relational data comprises three flat numeric values on three axes, and the processor is further configured to:
flatten the first vectors into the three flat numeric values.

16. The object management apparatus according to claim 11, wherein the first reference points comprise a plurality of vertices and an origin point, and the processor is further configured to:
determine a plurality of second vectors from the origin point to the vertices respectively; and
convert the second vectors into the geometric relational data.

17. The object management apparatus according to claim 16, wherein the geometric relational data comprises a hash value, and the processor is further configured to:
convert the second vectors into the hash value.

18. The object management apparatus according to claim 16, wherein the geometric relational data comprises a diagonal matrix, and the processor is further configured to:
decompose the second vectors into the diagonal matrix through singular value decomposition.

19. The object management apparatus according to claim 16, wherein the geometric relational data comprises three flat numeric values on three axes, and the processor is further configured to:
flatten the second vectors into the three flat numeric values.

20. The object management apparatus according to claim 11, wherein the geometric relational data comprises first type data or second type data, and the processor is further configured to:
set the similarity value of the first type data that is identical to the reference relational data to an upper limit value, wherein the upper limit value is an upper limit of the similarity value for single type data; or
set the similarity value according to an angle between a vector corresponding to the second type data and a vector corresponding to the reference relational data.
